(19) United States
(12) Patent Application Publication
(10) Pub. No.: US 2012/0239287 A1
(43) Pub. Date: Sep. 20, 2012

(54) COMPUTER-IMPLEMENTED METHOD AND SYSTEM FOR CONSTRUCTING VEHICLE GUIDANCE PATHS THAT OBEY DYNAMIC CONSTRAINTS

(75) Inventors: Joshua J. Pieper, Somerville, MA (US); Jeremy H. Brown, Somerville, MA (US); Matthew J. Marjanovic, Portland, OR (US)

(73) Assignee: Jaybridge Robotics, Inc., Cambridge, MA (US)

(21) Appl. No.: 13/481,353

(22) Filed: May 25, 2012

Related U.S. Application Data
(60) Provisional application No. 61/605,854, filed on Mar. 2, 2012.

(51) Int. Cl. G01C 21/00

(52) U.S. Cl. 701/400

(57) ABSTRACT

A computer-implemented method, system, and computer program product are provided for generating a pre-planned vehicle guidance path for a vehicle by transforming an initial piecewise linear path into a path that obeys a minimum vehicle turning radius constraint.

### CROSS REFERENCE TO RELATED APPLICATION

This application claims priority from U.S. Provisional Patent Application No. 61/605,854, filed on Mar. 2, 2012, entitled COMPUTER-IMPLEMENTED METHOD AND SYSTEM FOR CONSTRUCTING VEHICLE GUIDANCE PATHS THAT OBEY DYNAMIC CONSTRAINTS, which is hereby incorporated by reference.

### BACKGROUND

The present application generally relates to generating vehicle guidance paths for vehicles such as, e.g., driverless vehicles and semi-automated vehicles. More particularly, it relates to transforming a computer representation of an initial pre-planned vehicle path such that constraints on minimum turning radius are satisfied while leaving certain boundary conditions intact. It inter-operates with other vehicle trajectory manipulation modules to create a path that the vehicle is physically able to drive.

### BRIEF SUMMARY OF THE DISCLOSURE

A computer-implemented method in accordance with one or more embodiments generates a pre-planned vehicle guidance path for a vehicle by transforming an initial piecewise linear path into a path that obeys a minimum vehicle turning radius constraint. The method comprises the steps of: (a) receiving an initial piecewise linear path, a minimum vehicle turning radius constraint, and a maximum allowable error constraint; (b) sectioning the initial piecewise linear path into a series of connected linear segments, each having points at opposite ends; (c) evaluating each of the points along the piecewise linear path relative to its two immediately neighboring points to determine if an estimated local turning radius based on the point being evaluated and its neighboring points is smaller than the minimum turning radius constraint; (d) if the estimated local turning radius is smaller than the minimum turning radius constraint, moving the point being evaluated to a given point between the neighboring points; and (e) iteratively repeating steps (c) and (d) until there are no points forming an estimated local turning radius that is smaller than the minimum turning radius.

One or more further embodiments are directed to a computer system comprising at least one processor, memory associated with the at least one processor, and a program supported in the memory for generating a pre-planned vehicle guidance path for a vehicle by transforming an initial piecewise linear path into a path that obeys a minimum vehicle turning radius constraint. The program includes a plurality of instructions stored therein which, when executed by the at least one processor, cause the at least one processor to: (a) receive an initial piecewise linear path, a minimum vehicle turning radius constraint, and a maximum allowable error constraint; (b) section the initial piecewise linear path into a series of connected linear segments, each having points at opposite ends; (c) evaluate each of the points along the piecewise linear path relative to its two immediately neighboring points to determine if an estimated local turning radius based on the point being evaluated and its neighboring points is smaller than the minimum turning radius constraint; (d) if the estimated local turning radius is smaller than the minimum turning radius constraint, move the point being evaluated to a given point between the neighboring points; and (e) iteratively repeat steps (c) and (d) until there are no points forming an estimated local turning radius that is smaller than the minimum turning radius.

In accordance with one or more further embodiments, a computer program product is provided for generating a pre-planned vehicle guidance path for a vehicle by transforming an initial piecewise linear path into a path that obeys a minimum vehicle turning radius constraint. The computer program product resides on a non-transitory computer readable medium having a plurality of instructions stored thereon which, when executed by a computer processor, cause that computer processor to: (a) receive an initial piecewise linear path, a minimum vehicle turning radius constraint, and a maximum allowable error constraint; (b) section the initial piecewise linear path into a series of connected linear segments, each having points at opposite ends; (c) evaluate each of the points along the piecewise linear path relative to its two immediately neighboring points to determine if an estimated local turning radius based on the point being evaluated and its neighboring points is smaller than the minimum turning radius constraint; (d) if the estimated local turning radius is smaller than the minimum turning radius constraint, move the point being evaluated to a given point between the neighboring points; and (e) iteratively repeat steps (c) and (d) until there are no points forming an estimated local turning radius that is smaller than the minimum turning radius.

### BRIEF DESCRIPTION OF THE DRAWINGS

FIG. 1 is a simplified illustration showing an example of an initial path and a smoothed path obeying a minimum turning radius constraint in accordance with one or more embodiments.

FIG. 2 is a simplified illustration showing exemplary symmetric and asymmetric smoothing in accordance with one or more embodiments.

FIGS. 3-6 are simplified illustrations showing steps in an exemplary smoothing process in accordance with one or more embodiments.

### DETAILED DESCRIPTION

Various embodiments disclosed herein are directed to computer-implemented techniques of generating a pre-planned vehicle guidance path for a vehicle (such as, e.g., a driverless vehicle or a semi-automated vehicle) by transforming an initial piecewise linear path into a path that obeys a minimum vehicle turning radius constraint. In some cases, the vehicle has a minimum turning radius constraint. In other cases, the vehicle has no specified turning radius constraint, but larger turning radii are desired in order to enable higher speed operation. The minimum radius may also change during different stages of operation of the vehicle.

The initial vehicle path input to the system may not meet the minimum turning radius constraints. Often, initial representations of a vehicle path involve constraints such as, “drive along this boundary,” or “approximate the previous path offset by x meters.” Simple implementations of these primitives may result in vehicle paths that do not meet the vehicle's minimum turning radius constraints.

The vehicle may or may not have towed implements. If the towed implement is hinged, the larger minimum radius of the tractor and implement are used.

In various examples disclosed herein, the vehicle path is represented as a piecewise linear list of points in a two dimensional space. The smoothing techniques may be used on path representations that are continuous, if suitably approximated by a piecewise linear representation.

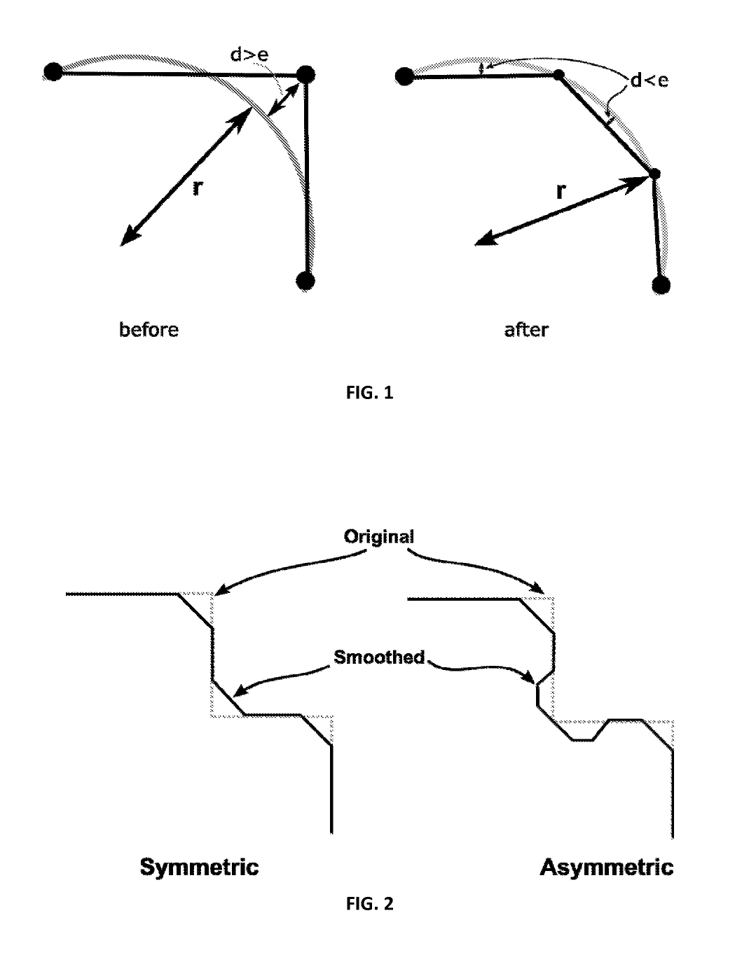

Methods in accordance with various embodiments transform a piecewise linear path (a path described as a series of straight-line segments) into one that is smoothed and obeys a minimum turning radius constraint. Specifically, the final path is constructed to never exceed a specified maximum distance e from an underlying curve described by minimum radius r. For example, FIG. 1 shows an initial path (identified as “before” in the figure) and a smoothed path (identified as “after” in the figure). Given an input minimum radius of curvature of r and a maximum approximation error parameter of e, the process guarantees that in the smoothed path, the maximum distance d from any point on any segment to the nearest point on an underlying curve with minimum radius r is less than or equal to e.

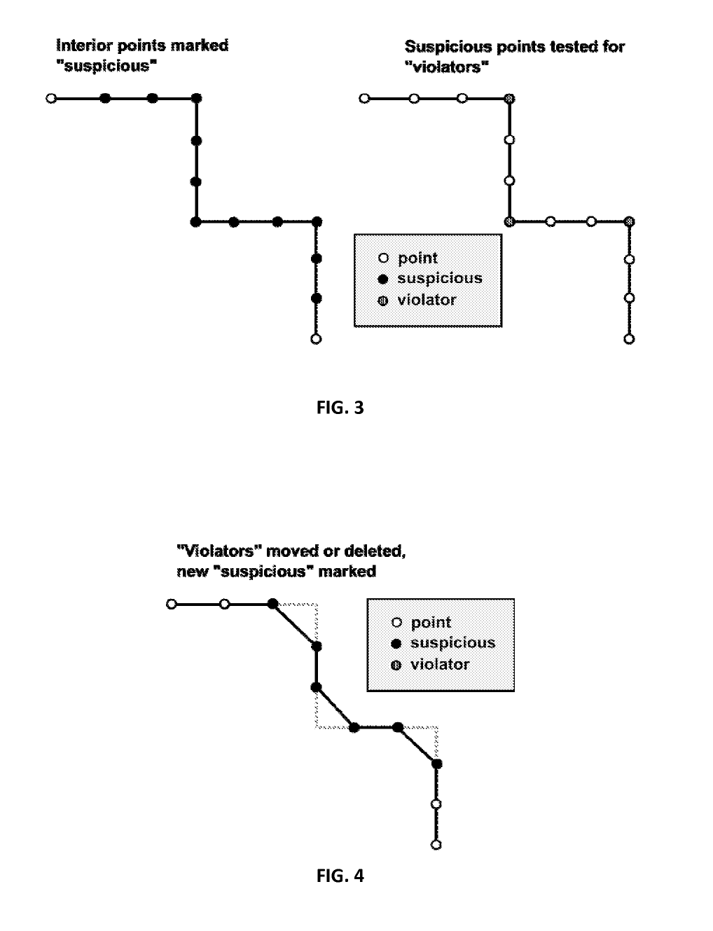

There are two variations of the process. In the first variation referred to as symmetric smoothing, approximation errors may be distributed on either side of the original path. In the second variation referred to as asymmetric smoothing, all approximation errors will lie to one chosen side of the original path. The distinction is illustrated in the exemplary paths shown in FIG. 2, where the dashed line is the input unsmoothed path, and the solid lines are the smoothed paths resulting from symmetric or asymmetric smoothing.

1. Symmetric Smoothing

The inputs are the minimum radius r, the maximum allowable error e, and the initial piecewise linear path p.

A symmetric smoothing process sequence in accordance with one or more embodiments is outlined as follows:

A. Super sampling: Each segment in p is sectioned into a sequence of segments such that no segment is longer than I_max, where I_max is chosen to guarantee that a piecewise linear representation can follow a curve of radius r while maintaining a maximum error e. By way of example, I_max can be calculated using the following formula:

I_max=2*sqrt((2*r*e)−(ê2)).

B. Zero-length segment discard: Any zero-length segments in p are discarded.

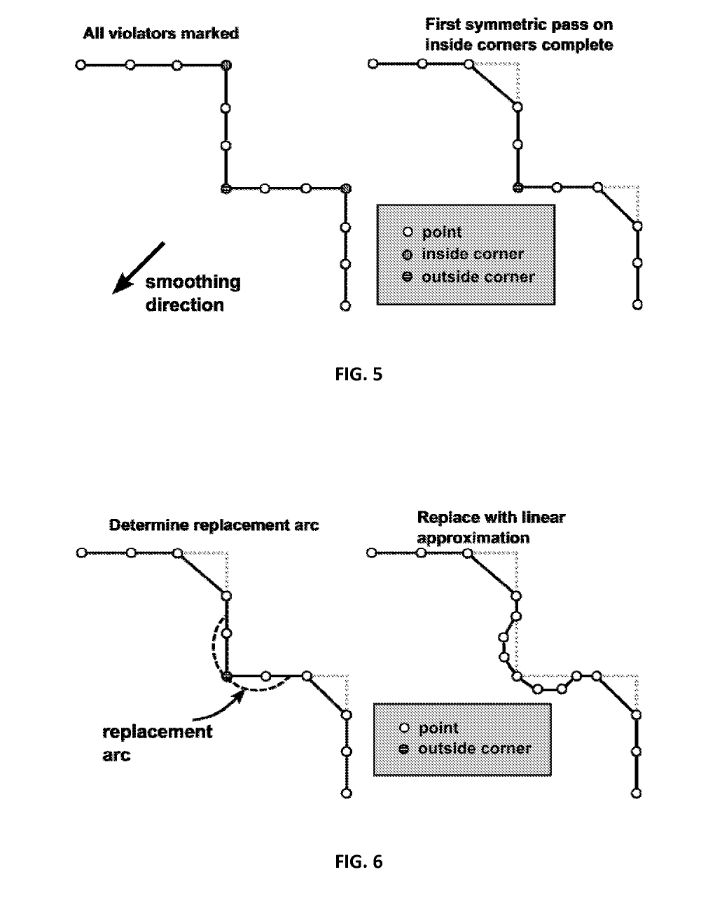

C. Suspicious marking: Every interior point in p is marked as “suspicious” as shown in FIG. 3.

D. Suspicious point testing: An interior point can be considered as the ‘B’ point in a sequence A-B-C with its neighbors on either side. Each suspicious point is tested to see if the “local radius” is smaller than the desired radius. The “local radius” is generally any form of local curvature estimate. By way of example, it can be determined as the circumradius of the point on the path in question and its two neighbors. If this test fails, i.e., the local radius is too small, the point is marked as a violator. Once all suspicious points have been tested, they are all unmarked as suspicious.

E. Path contraction iteration: As long as there are points marked as violators, two steps are repeated iteratively. In the first step, violators are moved according to the process about to be described. Second, step D, suspicious point testing is repeated.

F. Violator point movement: For each violating point in the path whose neighbors are not both violators, the point is marked for relocation to a given point (such as, e.g., the midpoint) between its neighbors. If the distance between its two neighbors is less than I_max, the point is simply marked for deletion. The two nearest neighbors to either side of the point, excluding the path endpoints, are marked as suspicious. When all points have been marked, points marked for deletion are deleted, and points marked for movement are moved as shown in FIG. 4.

2. Asymmetric Smoothing

In some instances, there are additional boundary constraints such as the initial path abuts an unsafe region and thus cannot be moved any further in that direction. For those instances, a variant of the above approach is provided that guarantees that the resulting path will either be to the left or right of the original path, where the handed-ness is an input to the process.

G. Inside corner movement: The symmetric steps A-F described above are performed, with the exception that violator corners are classified as either “inside” or “outside.” Inside corners are those that are oriented such that the point movement technique results in the line being moved in an acceptable direction. Outside corners are oriented such that midpoint movement would be in the other, unacceptable direction. In steps E-F, only the inside points are modified. After sufficient iteration, this leaves a path with only outside corners as shown in FIG. 5.

H. Outside corner grouping: The outside corners are grouped into contiguous ranges of points, where each range consists of entirely outside corners and is bounded by non-violators.

I. Outside group arc selection: For each outside group, an arc of the desired minimum radius is constructed, which (a) encloses all points in the outside group and (b) minimizes the deviation of the smoothed path from the original path. Many different heuristics may be used to find candidate arcs which satisfy (a). For example, one approach is to evaluate all arcs of the desired minimum radius that circumscribe path segments that neighbor points in the outside group. Another possible approach is to evaluate, for each point in the outside group, the arc of desired minimum radius on that point that is tangent to a circle circumscribing the point and its two neighbors. Many different heuristics also may be used to evaluate (b). For example, one approach is to choose the candidate arc that minimizes the area between the new arc and the original path.

J. Arc replacement: For each outside group, the selected region of path enclosed by the arc is replaced with a piecewise linear approximation of the arc as shown in FIG. 6. Once this step is complete, there will be no outside corners, although potentially new inside corners will have been introduced.

K. Final inside corner movement: To transform the final inside corner constraints, repeat the symmetric steps A-F on inside corners once again until no inside corners remain.

The processes for constructing vehicle guidance paths described above are computer-implemented and may be implemented in software, hardware, firmware, or any combination thereof. The processes are preferably implemented in one or more computer programs executing on a programmable computer system including at least one processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions.

Accordingly, the foregoing description and attached drawings are by way of example only, and are not intended to be limiting.

1. A computer-implemented method of generating a pre-planned vehicle guidance path for a vehicle by transforming an initial piecewise linear path into a path that obeys a minimum vehicle turning radius constraint, the method comprising the steps, each performed by a computer system, of:
(a) receiving an initial piecewise linear path, a minimum vehicle turning radius constraint, and a maximum allowable error constraint;
(b) sectioning the initial piecewise linear path into a series of connected linear segments, each having points at opposite ends;
(c) evaluating each of the points along the piecewise linear path relative to its two immediately neighboring points to determine if an estimated local turning radius based on the point being evaluated and its neighboring points is smaller than the minimum turning radius constraint;
(d) if the estimated local turning radius is smaller than the minimum turning radius constraint, moving the point being evaluated to a given point between the neighboring points; and
(e) iteratively repeating steps (c) and (d) until there are no points forming an estimated local turning radius that is smaller than the minimum turning radius.

2. The method of claim 1, wherein none of the segments has a length exceeding a given length, said given length selected to ensure that the piecewise linear path can follow a curve of the minimum vehicle turning radius while obeying the maximum allowable error constraint.

3. The method of claim 2, wherein the given length is calculated using the following formula:
I_max=2*sqrt((2*r*e)−(ê2)),
where I_max is the given length, r is the minimum vehicle turning radius constraint, and e is the maximum allowable error constraint.

4. The method of claim 2, wherein step (d) comprises: (d) if the estimated local turning radius is smaller than the minimum turning radius constraint and the distance between the neighboring points is equal to or greater than the given length, moving the point being evaluated to a given point between the neighboring endpoints, and wherein if the distance between the neighboring points is less than the given length, deleting the point being evaluated.

5. The method of claim 1, wherein the given point is the midpoint between the neighboring points.

6. The method of claim 1, wherein the vehicle includes a towed implement, and wherein the minimum vehicle turning radius constraint is based on the minimum turning radius of the vehicle and the minimum turning radius of the towed implement.

7. The method of claim 1, wherein the piecewise linear path is an approximated representation of a continuous path.

8. The method of claim 1, wherein points defining the piecewise linear path can only be moved in an acceptable direction, the method further comprising classifying points at corners of the piecewise linear path as an inside corner or an outside corner, wherein an inside corner is one that is oriented such that movement of a corner point to a point between neighboring points results in movement of the piecewise linear path in an acceptable direction, and wherein an outside corner is one that is oriented such that movement of the corner point to a point between neighboring points results in movement of the piecewise linear path in an unacceptable direction, and wherein steps (c), (d), and (e) are performed for inside corner points but not outside corner points.

9. The method of claim 8, wherein for outside corner points, the method further comprises:
(f) selecting an arc that encloses an outside corner point and neighboring points, said arc having a generally minimal deviation from the outside corner point and neighboring points;
(g) replacing the arc with a piecewise linear approximation of the arc; and
(h) iteratively repeating steps (c), (d), and (e) for any inside corners formed in (g).

10. The method of claim 1, wherein the estimated local turning radius comprises a circumradius defined by points.

11. A computer system, comprising:
at least one processor;
memory associated with the at least one processor; and
a program supported in the memory for generating a pre-planned vehicle guidance path for a vehicle by transforming an initial piecewise linear path into a path that obeys a minimum vehicle turning radius constraint, the program having a plurality of instructions stored therein which, when executed by the at least one processor, cause the at least one processor to:
(a) receive an initial piecewise linear path, a minimum vehicle turning radius constraint, and a maximum allowable error constraint;
(b) section the initial piecewise linear path into a series of connected linear segments, each having points at opposite ends;
(c) evaluate each of the points along the piecewise linear path relative to its two immediately neighboring points to determine if an estimated local turning radius based on the point being evaluated and its neighboring points is smaller than the minimum turning radius constraint;
(d) if the estimated local turning radius is smaller than the minimum turning radius constraint, move the point being evaluated to a given point between the neighboring points; and
(e) iteratively repeat steps (c) and (d) until there are no points forming an estimated local turning radius that is smaller than the minimum turning radius.

12. The computer system of claim 11, wherein none of the segments exceeds a given length, said given length selected to ensure that the piecewise linear path can follow a curve of the minimum vehicle turning radius while obeying the maximum allowable error constraint

13. The computer system of claim 12, wherein the given length is calculated using the following formula:
I_max=2*sqrt((2*r*e)−(ê2)),
where I_max is the given length, r is the minimum vehicle turning radius constraint, and e is the maximum allowable error constraint.

14. The computer system of claim 12, wherein (d) comprises: (d) if the estimated local turning radius is smaller than the minimum turning radius constraint and the distance between the neighboring points is equal to or greater than the given length, move the point being evaluated to a given point between the neighboring endpoints, and wherein if the distance between the neighboring points is less than the given length, delete the point being evaluated.

15. The computer system of claim 11, wherein the given point is the midpoint between the neighboring points.

16. The computer system of claim 11, wherein the vehicle includes a towed implement, and wherein the minimum vehicle turning radius constraint is based on the minimum turning radius of the vehicle and the minimum turning radius of the towed implement.

17. The computer system of claim 11, wherein the piecewise linear path is an approximated representation of a continuous path.

18. The computer system of claim 11, wherein points defining the piecewise linear path can only be moved in an acceptable direction, and the at least one processor is further caused to classify points at corners of the piecewise linear path as an inside corner or an outside corner, wherein an inside corner is one that is oriented such that movement of a corner point to a point between neighboring points results in movement of the piecewise linear path in an acceptable direction, and wherein an outside corner is one that is oriented such that movement of the corner point to a point between neighboring points results in movement of the piecewise linear path in an unacceptable direction, and wherein (c), (d), and (e) are performed for inside corner points but not outside corner points.

19. The computer system of claim 18, wherein for outside corner points, the at least one processor is further caused to:
(f) select an arc that encloses an outside corner point and neighboring points, said arc having a generally minimal deviation from the outside corner point and neighboring points;
(g) replace the arc with a piecewise linear approximation of the arc; and
(h) iteratively repeat steps (c), (d), and (e) for any inside corners formed in (g).

20. The computer system of claim 11, wherein the estimated local turning radius comprises a circumradius defined by points.

21. A computer program product for generating a pre-planned vehicle guidance path for a vehicle by transforming an initial piecewise linear path into a path that obeys a minimum vehicle turning radius constraint, said computer program product residing on a non-transitory computer readable medium having a plurality of instructions stored thereon which, when executed by a computer processor, cause that computer processor to:
(a) receive an initial piecewise linear path, a minimum vehicle turning radius constraint, and a maximum allowable error constraint;
(b) section the initial piecewise linear path into a series of connected linear segments, each having points at opposite ends;
(c) evaluate each of the points along the piecewise linear path relative to its two immediately neighboring points to determine if an estimated local turning radius based on the point being evaluated and its neighboring points is smaller than the minimum turning radius constraint;
(d) if the estimated local turning radius is smaller than the minimum turning radius constraint, move the point being evaluated to a given point between the neighboring points; and
(e) iteratively repeat steps (c) and (d) until there are no points forming an estimated local turning radius that is smaller than the minimum turning radius.

22. The computer program product of claim 21, wherein none of the segments exceeds a given length, said given length selected to ensure that the piecewise linear path can follow a curve of the minimum vehicle turning radius while obeying the maximum allowable error constraint.

23. The computer program product of claim 22, wherein the given length is calculated using the following formula:
I_max=2*sqrt((2*r*e)−(ê2)),
where I_max is the given length, r is the minimum vehicle turning radius constraint, and e is the maximum allowable error constraint.

24. The computer program product of claim 22, wherein (d) comprises: (d) if the estimated local turning radius is smaller than the minimum turning radius constraint and the distance between the neighboring points is equal to or greater than the given length, move the point being evaluated to a given point between the neighboring endpoints, and wherein if the distance between the neighboring points is less than the given length, delete the point being evaluated.

25. The computer program product of claim 21, wherein the given point is the midpoint between the neighboring points.

26. The computer program product of claim 21, wherein the vehicle includes a towed implement, and wherein the minimum vehicle turning radius constraint is based on the minimum turning radius of the vehicle and the minimum turning radius of the towed implement.

27. The computer program product of claim 21, wherein the piecewise linear path is an approximated representation of a continuous path.

28. The computer program product of claim 21, wherein points defining the piecewise linear path can only be moved in an acceptable direction, and further comprising instructions that cause the processor to classify points at corners of the piecewise linear path as an inside corner or an outside corner, wherein an inside corner is one that is oriented such that movement of a corner point to a given point between neighboring points results in movement of the piecewise linear path in an acceptable direction, and wherein an outside corner is one that is oriented such that movement of the corner point to a given point between neighboring points results in movement of the piecewise linear path in an unacceptable direction, and wherein (c), (d), and (e) are performed for inside corner points but not outside corner points.

29. The computer program product of claim 28, wherein for outside corner points, computer program product further includes instructions for causing the processor to:
(f) select an arc that encloses an outside corner point and neighboring points, said arc having a generally minimal deviation from the outside corner point and neighboring points;
(g) replace the arc with a piecewise linear approximation of the arc; and
(h) iteratively repeat steps (c), (d), and (e) for any inside corners formed in (g).

30. The computer program product of claim 21, wherein the estimated local turning radius comprises a circumradius defined by points.
